(19) United States
(12) Patent Application Publication
(10) Pub. No.: US 2023/0263149 A1
(43) Pub. Date: Aug. 24, 2023

(54) Hand-Held Insect Eliminator

(71) Applicant: Stephen James Coughlin, Mountain View, CA (US)

(72) Inventor: Stephen James Coughlin, Mountain View, CA (US)

(21) Appl. No.: 17/676,812

(22) Filed: Feb. 21, 2022

(51) Int. Cl. A01M 3/00

(52) U.S. Cl. CPC A01M 3/00

(57) ABSTRACT

This Hand-Held Insect Eliminator is a device comprising two flaps of optimal size and shape, which are connected at one end by a hinge. Intelligently designed integrated finger housings at the hinged end allow the device to be easily opened and snapped shut by a wide variety of hand and finger sizes. The device can be used on many types of insects, whether flying, hanging, crawling, or at rest. It can be operated in mid-air, against a wall, ceiling, or directly against a surface, or just above a surface, depending on the type and location of the insect. The device incorporates a unique containment grid which allows the elimination to be done cleanly.

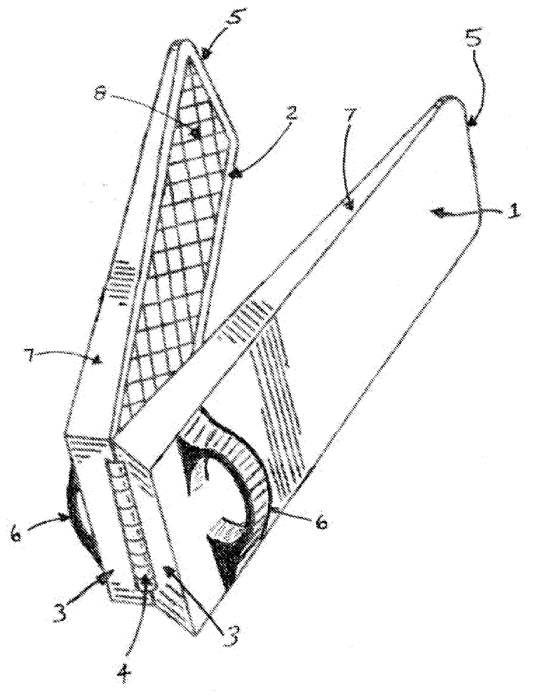

### BACKGROUND OF THE INVENTION

### 1. Field of Invention

This invention relates generally to a device for eliminating insects and other pests at rest or in flight, i.e., a better fly swatter. Development of fly swatters has continued for many decades, yet problems with pest elimination persist. To address the problems, some fly swatters have joined two blades in a closing motion. While these devices may have operated satisfactorily, they have not been found to be entirely suitable, being unnecessarily complex or of limited utility. Thus, there remains a need in the art for providing a simpler and better fly swatter.

As used herein, the term “insect” is meant to include both the usual class of invertebrate arthropods characterized by a segmented body consisting of a head, thorax, and abdomen, three pairs of jointed legs, usually two pair of wings, and one pair of antennae, including bees, flies, and beetles; and additionally, arachnids, the class characterized by a two-part body, four pairs of jointed legs, and no wings or antennae, including spiders, scorpions and ticks.

An object of the present invention is the provision of an insect eliminator to eliminate an insect more cleanly and effectively than a conventional fly swatter, use of the hand or newspaper, without the use of chemical sprays or electricity. Another object of the invention is the provision of an insect eliminator to be used in midair to kill flying insects and suspended spiders. A further object of the invention is to be used as tongs to pick up or crush beetles and other crawling insects on the ground or other flat level surface. A still further object of the invention is to be used directly adjacent to a wall, ceiling, or other surface, to pick up or crush the insect without staining, scratching, or otherwise damaging the surface with the remains of the crushed insect.

### 2. Description of Prior Art

Linding U.S. Pat. No. 1,660,011 discloses a metallic scissors-like device requiring the use of multiple fingers for crushing an insect but without any containment grid. Use of metal, although durable, adds unnecessary weight and cost.
Chapman U.S. Pat. No. 1,081,364 discloses a stationary device that operates as a trap mainly for flying insects. This invention is actuated by an insect landing on its hinged members and requires no participation by a human operator.
Dougherty U.S. Pat. No. 3,191,339 discloses an elongated umbrella-like apparatus where the user manipulates a rod attached to flaps that open and close upon an insect through the opening or closing of the flaps along a rod. This device could not be used on a flat surface.
Teate U.S. Pat. No. 502,056 discloses a ceiling hanging structure of two flaps facing each other. The invention requires an attractant for the pests. Operation is through a cord that allows for the momentum of the two flaps to close against insects lured by the attractant.
Person U.S. Pat. No. 5,029,549 discloses a tong-like apparatus with cups at its distal end that pivots in scissors fashion. Upon targeting an insect or insects the tongs can be directed to capture the insect in the cups. The insect or insects are not killed.
Voss U.S. Pat. No. 1,664,762 discloses an apparatus comprised of two opposite facing plates that are further comprised of a metallic frame and screen mesh. The plates are moved together with the hand similar to the operation of a baseball glove. The plates' movement is guided by springs where the frames are attached at the hinge with a flexible element attached to both frames.

The aforementioned prior art kill insects through the closing of plates or flaps to capture or kill insects through crushing. The inventions disclosed by Linding, Chapman, Dougherty, Teate, and Person have weight or mechanics that preclude the rapid deployment required to capture nimble and fast-moving insects, many of which fly. The invention disclosed by Voss also has weight and mechanics issues, requiring the use of force from the entire hand, which is suitable for slower moving larger insects but precludes the coordinated precision to capture and crush faster, smaller moving insects, and the metal mesh does not contain the crushed insect parts.

### BRIEF SUMMARY OF THE INVENTION

The present invention achieves the aforementioned objects by providing an insect eliminator device that comprises a pair of flaps, each of which has an interior face and an exterior face. The interior face of one flap faces the interior face of the other flap. The flaps each have a front end, a connector end, and a pair of side ends. The front end of each flap is opposite to the connector end and perpendicular to the side ends. A flap connector, such as a hinge, is attached to the connector end of the flaps. Each of the flaps are constructed to be grasped by the operator to facilitate operation of the insect eliminator device. The thickness of the flaps decreases from thick to thin in the direction away from the connector end of the flaps. The side ends of both flaps are rounded at the intersection with the front ends. The flaps have a grid which is defined by an array of grooves on the interior face of the flaps. The flaps could be constructed from a wide variety of materials and forms, but would optimally be made from rigid lightweight plastic, for low cost, low weight and ease of manufacture. The insect eliminator described herein has the advantages of being highly effective, simple and easy to use, allowing for speed and accuracy of hand actuation, expansion of the range of the operator's reach, and it can be produced and sold at low cost to both the manufacturer and consumer. An additional advantage is the avoidance of smudging, staining, scuffing, tearing, or other types of surface damage normally encountered with a conventional device, and this insect eliminator fully contains the crushed or captured insect. Removal or elimination can take place in a different area suitable to the user.

### BRIEF DESCRIPTION OF THE DRAWING

The objects and advantages of this invention will be readily appreciated and understood by reference to the following detailed description when considered in connection with the accompanying drawing, which shows a top perspective view of an insect eliminator of the present invention, in which like reference numerals designate like parts throughout the drawing.

### DETAILED DESCRIPTION OF THE INVENTION

The present invention is illustrated by way of example in the accompanying drawing, in which an insect eliminator device comprises an identical pair of flaps, each of which has an interior face 2 and an exterior face 1. The interior face 2 of one flap faces the interior face 2 of the other flap. Research and testing determined the optimal length, width, and color of the flaps, said color being a red of 670-700 nm wavelength. The flaps each have a front end 5 of 4 inches width, a connector end 3 of 4 inches width, and a pair of side ends 7 of 10 inches length. The front end 5 of each flap is opposite to its connector end 3 and perpendicular to its side ends 7. A pivoting flap connector 4, such as a hinge, is attached to the connector end 3 of each flap. The thickness of each flap from exterior face 1 to interior face 2 decreases from ¾ of an inch at the connector end 3 to ⅜ of an inch at the front end 5. The side ends 7 of each flap are rounded at their intersection with the front end 5, providing the operator with the means to eliminate a crawling insect by easily picking it off walls, clothing, table tops, lamp shades, etc. The integrated finger housing 6 was designed using biometric research to yield the optimum location, size, and shape to allow utilization by a wide range of operator hand and finger sizes. Finger housing 6 is integrated into the exterior face 1 of each flap, arising perpendicularly from exterior face 1 not more than ⅝ of an inch from the connector end 3 of each flap, with an ellipsoidal opening of 1 inch in height, 2 inches in width, and 1 inch in length, which allows the operator's thumb to engage one flap and at least one finger to engage the other flap. Each flap has a grid 8 on its interior face 2, which is defined by an array of interconnected grooves designed for maximum containment of the remains of the crushed insect. The grid 8 is comprised of a perimeter rectangle groove ¼ of an inch from each edge of interior face 2 and an interior array of grooves not more than ½ inch apart from each other, intersecting at 90-degree angles to each other and at 45-degree angles to the perimeter rectangle, said grooves all being 1/32 of an inch in depth and 1/32 of an inch in width. Dimensions given herein have been carefully researched, calculated, and tested to provide complete crush containment of a wide variety of insects. Data was obtained from multiple sources, including researchgate.net, University of Florida (entnemdept.uff.edu), animaldiversity.com, and physicsforum.com, which yielded the following information. The common housefly (Musca domestica) ranges in size from 4 to 8 mm, with an average length 6.4 mm and an average mass of 12 mg. S. bullata, a fly common in the northeastern U.S. can be up to 17 mm in length and 45 mg in mass. Common hornets can reach 30 mm with an average mass of 480 mg. Reported density of these insects is 100 kg/m\hat{ }3. Containing insects of this larger size requires two critical attributes of the grid 8: a circuitous path to the edge of the array and sufficient volume. The circuitous path is achieved by having the interior array grooves intersect the perimeter rectangle groove at 45-degree angles, as this prevents any fluid from moving directly along the shortest path to any edge of the device. The total volume of the grooves is even more critical. Since a 480 mg hornet as likely to be at or near the maximum size normally encountered, its mass can be used with the 100 kg/m\hat{ }3 density to calculate its volume, and thus the maximum volume the device would be required to contain:

(0.00048 kg)×(1 m\hat{ }3/100 kg)×(1E9 mm\hat{ }3/m\hat{ }3)=4800 mm\hat{ }3=0.29 cubic inches

Using the flap and grid dimensions given above, the containment grid's total volume is calculated by adding up the total length of all the grooves on one flap, then multiplying it by their width and depth, then multiplying by two, to account for the other flap:

(146 inches×0.03125 inches×0.03125 inches)×2=0.29 cubic inches

The two calculated volumes being equal shows that the large insect will be fully contained. Furthermore, assuming the insect is not entirely liquidous, it should still be fully contained even if not crushed directly in the center of the grid. Smaller insects will be fully contained even if crushed close to the edges of the grid. It has been clearly shown here that the critical design and dimensions delineated above yield an insect elimination device of optimum utility and functionality, superior to any prior art.

1. A hand-held insect eliminator, comprising:
A pair of identical lightweight solid flaps, each having an interior face and an exterior face, nominally tapering from ¾ of an inch to ⅜ of an inch in thickness, hinged together at the thicker end, each with an integrated ellipsoidal finger housing at the hinged end for grasping and operating, similar to some aspects of prior art, but with a novel feature that makes this device unique and superior to prior art, said novel feature being a containment grid defined by an array of interconnected grooves to contain the liquid resulting from crushing an insect between the flaps. The critical dimensions of the device are as follows: the identical flaps are 4 inches in width by 10 inches in length, having a containment grid comprised of a perimeter rectangle groove ¼ of an inch from each edge of the interior face, and an interior array of grooves comprised of two sets of parallel grooves in a cross-hatch pattern, intersecting at 90-degree angles to each other and terminating at 45-degree angles into the perimeter rectangle, said parallel grooves being not more than ½ of an inch apart from each other, all grooves being 1/32 of an inch in depth and 1/32 of an inch in width.
